(19) United States
(12) Patent Application Publication
(10) Pub. No.: US 2004/0204941 A1
(43) Pub. Date: Oct. 14, 2004

(54) Digital transcription system and method

(75) Inventors: David Israch, Plantation, FL (US); Yorck P. Haase, Boca Raton, FL (US); Alind Gupta, Jaipur (IN); Pavan Jha, Jaipur (IN); Devesh Bhartiya, Jaipur (IN); Scott C. Boterweg, Wellington, FL (US); Philip Austin, Coconut Creek, FL (US); Fazil Atacan, Boca Raton, FL (US)

Correspondence Address: Alan M. Weisberg, Christopher & Weisberg, P.A., Suite 2040, 200 East Las Olas Boulevard, Fort Lauderdale, FL, 33301, US

(73) Assignee: WeType4U

(21) Appl. No.: 10/746,336

(22) Filed: Dec. 23, 2003

Related U.S. Application Data
(60) Provisional application No. 60/458,826, filed on Mar. 28, 2003.

(51) Int. Cl. G10L 15/12; G10L 15/08

(52) U.S. Cl. 704/240

(57) ABSTRACT

A digital voice transcription system and method is provided having a digital communication network and a first server operatively coupled to the digital communication network. The first server stores a digital transcription job file corresponding to an author's voice and allocates stored job files for transcription. A second server corresponding to a transcription center is operatively coupled to the digital communication network. The second server is in digital communication with the first server and is arranged to initiate transfer of digital transcription job files allocated to the second server from the first server to the second server.

### CROSS-REFERENCE TO RELATED APPLICATION

This application is related to and claims priority to U.S. Provisional Patent Application Serial No. 60/458,826, filed Mar. 28, 2003, entitled AUDIO CAPTURE AND DISTRIBUTION SYSTEM, the entirety of which is incorporated herein by reference.

### STATEMENT REGARDING FEDERALLY SPONSORED RESEARCH OR DEVELOPMENT

### FIELD OF THE INVENTION

This invention relates to digital transcription systems and methods, and in particular to hierarchical digital transcription systems and methods arranged to accommodate transcription input from a multitude of sources and in a multitude of formats.

### BACKGROUND OF THE INVENTION

Transcribing the spoken voice unto paper documentation has long been a part of business culture. The advent of the typewriter, word processor and computer, coupled with the seeming explosion of documents produced over the last fifty years has placed great demand on the need for efficient transcription of human voice to paper documentation.

The most rudimentary of transcription systems was traditionally the secretary taking shorthand and transcribing the shorthand using a typewriter or computer to produce a typed or printed document. Transcription systems evolved with advent of the tape recorder such that an author could dictate his or her voice into the recorder, provide the tape to the transcriptionist who would then type the document. This arrangement worked and continues to work well in small environments where it is simple to pass the tape to the transcriptionist. However, authors who travel and need to have their dictation typed while on the road find this arrangement inefficient. Further, this arrangement only works if there is a transcriptionist available to transcribe the spoken word.

Analog transcription systems are known in which a transcribing unit in the form of a microphone and suitable controls are coupled to a large centralized recording device. These systems are typically implemented in a building environment, such as a hospital, insurance company facility, and the like in which there are large number of authors and a large pool of transcriptionists. Due to their analog nature, these systems are not implementable across wide geographic areas, because large and complex wiring must be implemented along with the systems. Further, the complex mechanical nature of these systems makes them highly prone to breakage, thereby reducing the overall efficiency of the system and increasing the cost of such a system. These systems also do not readily lend themselves to remote access where the author is not in the same building and does not have the means to access a system-connected recording device. It is desirable to have a system which can be implemented over a large geographic distance which is not mechanically complex in nature yet offers the flexibility to accommodate any number of authors and a pool of transcriptionists.

Systems have also been proposed in which an author uses the telephone system to remotely access the recording device. However, these systems are cumbersome to use and are not flexible enough to accommodate both analog and digital forms of dictation entry.

With the advent of digital recording and transmission technologies, transcription systems which use digital communication networks have become available. For example, a system has been proposed in which a digital representation of the author's voice is transmitted across the Internet using streaming audio technology to a transcriptionist who then transcribes the author's voice into the desired document. These systems are prone to error and inefficiencies due to the unreliable nature of streaming audio across the Internet. In such examples, dropped data packets result in lost portions of the author's dictation. Further, because these streaming technologies typically require a very high rate of audio compression, the quality of the audio received by the transcriptionist is often poor, thereby facilitating transcribing errors. It is therefore desirable to have a transcription system which uses a digital data communication network such as the Internet to transmit audio data from the author to the transcriptionist in a manner which is not prone to error and results in a high quality audio file being made available to the transcriptionist.

Transcription systems using the Internet have been proposed in which an author transmits dictation to a centralized transcription server in which the transcriptionist accesses the transcribe server to pull audio files for transcription for subsequent typing and document entry. However, these systems contain a number of disadvantages. First, because the transcriptionist must access the remote transcription server to “pull” the audio file to the transcription workstation, the transcription server can be overloaded with data communication requests, thereby overloading the transcription server as well as the supporting communication network. Second, a “pull”-system includes inherent inefficiencies because the transcriptionist must initiate the transfer, rather than a situation in which the system monitors transcriptionist's activities, queues up subsequent jobs for the transcriptionist and “pushes” the job to the transcriptionist upon completion of the previous job. Third, such systems are not readily scalable to accommodate large numbers of users and transcriptionists without the replacement of the transcription server with a large-scale computing device. Such devices are expensive to install and maintain and often require dedicated raised-floor computing centers for implementation. Even then, scalability is problematic due to the above-described communication and input/output constraints. Fourth, a system which merely provides for a transcription server and transcriptionist stations for the exchange of audio files and completed documents makes no provision for quality control and/or customer service functions to ensure that the transcribed document is error-free and meets the requirement of the author. Adding still additional workstations to the system in the form of quality control and/or customer service computing devices places additional load on the centralized transcription server.

It is therefore desirable to have a transcription system and supporting methods which overcome the above-described deficiencies to in order to provide an efficient, scalable system which supports multiple forms of dictation entry into the system, coupled with an arrangement which maximizes transcriptionist utilization. It is further desirable that such a system include provisions for quality control and/or customer service functions.

Although forms of dictation entry are known which allow an author to enter dictation via telephone, facsimile and the transfer of digitized audio files to a centralized server, such a system which can efficiently handle all of these forms of dictation entry and provide an integrated system component which allows an author to dictate directly into his or her computer to initiate an automated transfer of the file to the appropriate servers for subsequent transmission are not known. It is therefore also desirable to provide a dictation system which provides a robust yet flexible means for dictation entry, including the ability to record one's voice directly into a computer, such as a personal computer, for automated transmission, including account information, preferences, priority, and the like, to a server for subsequent transcription.

### SUMMARY OF THE INVENTION

The present invention advantageously provides a hierarchical digital transcription method and system which, among other things, can accommodate audio file input in a multitude of formats. The invention provides an efficient set of processes for allocating jobs to transcription centers, allows for monitoring the progress of the jobs as well as a way to manage quality control over the jobs. The invention provides the completed transcribed jobs to the author via email or other designated delivery method period.

According to an aspect, the present invention provides a digital voice transcription system in which there is a digital communication network. A first server is operatively coupled to the digital communication network and stores a digital transcription job file corresponding to an author's voice. The first server allocates stored job files for transcription. A second server corresponding to a transcription center is operatively coupled to the digital communication network. The second server is in digital communication with the first server and is arranged to initiate transfer of digital transcription job files allocated to the second server from the first server to the second server.

According to another aspect, the present invention provides a digital voice transcription method in which a digital transcription job file corresponding to an author's voice is stored. Stored job files are allocated for transcription in which the allocation includes assigning a transcription center and transcriptionist. Digital transcription job files allocated to the transcription center are transferred to a server corresponding to the allocated transcription center. The file transfer is initiated by the server corresponding to the allocated transcription center.

According to still another aspect, the present invention provides a digital transcription method for a transcription system having a centralized location and at least one transcriptionist center in which at least one transcriptionist is assigned to each of the at least one transcriptionist centers. According to the method, a transcription job is received at the centralized location. The transcription job is allocated to a transcription center and transcriptionist. The allocated transcription center initiates transfer of the allocated job from the centralized location to the allocated transcription center. The transcription job is processed within the allocated transcription center to create a transcribed document. The transcribed document is transferred to the centralized location.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a transcription system constructed in accordance with the principles of the present invention;

FIG. 2 is a block diagram of functional component of a PIA server constructed in accordance with the principles of the present invention; 100181 FIG. 3 is a block diagram of functional components of an SIA server constructed in accordance with the principles of the present invention;

FIG. 4 is a flow chart showing an exemplary overall process of the present invention;

FIG. 5 is a flow chart showing the job process flow by transcription center constructed in accordance with the principles of the present invention;

FIG. 6 is a flow chart showing the process of allocating a job to a pre-assigned transcriptionist;

FIG. 7 is a flow chart showing an example of quality control processing;

FIG. 8 is a flow chart showing an example of customer management system processing;

FIG. 9 shows an exemplary display screen for a primary intelligent agent constructed in accordance with the principles of the present invention;

FIG. 10 shows an exemplary display screen for a secondary intelligent agent constructed in accordance with the principles of the present invention;

FIG. 11 shows an exemplary user interactive display screen for voice capture software running on a customer computer constructed in accordance with the principles of the present invention; and

FIG. 12 shows an exemplary setup display screen for voice capture software running on a customer computer constructed in accordance with the principles of the present invention

### DETAILED DESCRIPTION OF THE INVENTION

As used herein the term “job” refers to a transcription task including all aspects of processing, from receipt of the information to be recorded from the author to final delivery of the transcribed document to the end customer. Also as used herein, the term “author” refers to a consumer of transcription services, and is not limited to the person who dictated the audio to be transcribed.

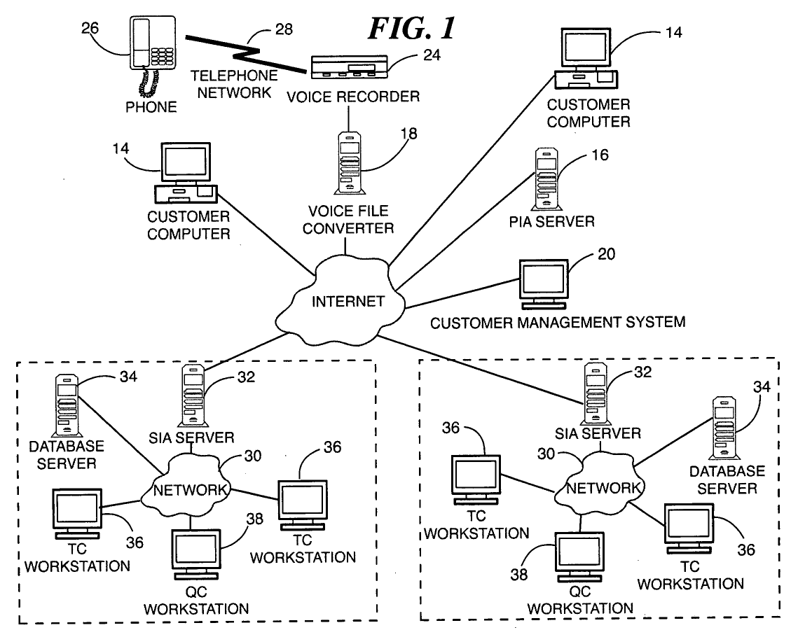

Referring now to the drawing figures in which like reference designators refer to like elements, there is shown in FIG. 1 a transcription system constructed in accordance with the principles of the present invention and designated generally as 10. As shown in FIG. 1, transcription system 10 includes a digital communication network such as the Internet 12 to which is coupled one or more customer computers 14, primary intelligent agent (“PIA”) server 16, voice file converter 18, customer management system 20, and one or more transcription centers 22. Although FIG. 1 shows only a single PIA server 16, it is contemplated that multiple PIA servers can easily be implemented to support the functions described below.

Transcription system 10 further includes one or more voice recorders 24 coupled to telephones 26 via the public switched telephone network 28. Each transcription center 22 includes its own communication network 30, such as a local area network, metropolitan area network, wide area network, etc. to which is coupled secondary intelligent agent (“SIA”) server 32, database server 34, one or more transcription center workstations 36, and quality control (“QC”) station 38. It is also understood that communication between the devices shown in FIG. 1 and Internet 12 can be wired or wireless connections and any combination thereof.

Although FIG. 1 shows a single SIA server 32, single database server 34 and a single QC workstation 38, it is contemplated that multiple servers and workstations can be implemented without departing from the spirit of the present invention. Further, although FIG. 1 shows separate computing devices to support the different functions of the present invention, it is contemplated that one or more of the functions and servers/workstations/converters can be grouped together and supported on fewer numbers of hardware devices. For example, it is contemplated that voice file converter 18 and PIA server 16 can be implemented as a single piece of hardware. As still another example, it is contemplated that SIA server 32 and database server 34 can be implemented on a single computing platform.

Customer computer 14 can be any microprocessor or microcontroller-based device, such as personal computer, PDA, tablet computer, notebook computer, and the like capable of communicating with PIA server 16 via Internet 12. It is contemplated that one of ordinary skill in the art can arrange customer computer 14 to include sufficient processing, storage, input and output devices to support the functions described herein. Customer computer 14 preferably includes email and/or file transfer capabilities as well as the ability to communicate using a suitable communication protocol such as the Transmission Control Protocol/Internet Protocol (“TCP/IP”).

The system of the present invention advantageously allows an author to submit a job for transcription using one of many different methods. By way of non limiting example, an author can dictate directly into customer computer 14 via microphone and arrange to have customer computer 14 automatically encode the author's voice using a suitable encoding method, such as Moving Picture Experts Group-1 audio layer 3 (“MP3”) compression, and transmit the file to PIA server 16. An author may also couple a traditional analog tape recorder to customer computer 14 and execute a process by which customer computer 14 digitizes the analog recording and transmits the digitized audio to PIA server 16. As still another example, an author may create a digitized file comprising the job to be transcribed and transmit it to PIA server 16 as an email attachment or using a suitable transmission protocol such as the file transmission protocol (“FTP”). Methods of attaching files to email and transmitting the same to a remote location and methods for transmitting files using FTP are known and are not described herein.

Also, although not shown in FIG. 1, it is contemplated that an author can fax a document or part of a document needed for rework and/or additional transcription to PIA server 16 via known methods. Such faxed document can be further processed using optical character recognition (“OCR”) technology and/or retyped by a transcriptionist as necessary. Also, although not shown, it is contemplated that an author can send the physical analog recording and/or memory card containing a digitized version of the recording of the job to be transcribed to the location of PIA server 16 or customer management system 20 for digitization and/or transmission to PIA server 16. In other words, it is contemplated that the author can transmit the tangible medium containing the voice file to a location operated by the transcription service provider for entry into system 10 in much the same manner as if the author had done the transmission to PIA server 16 from customer computer 14.

Still another method of dictation input from an author is via phone 26. In operation, the author uses phone 26 to communicate with voice recorder 24 over public switched telephone network 28. Voice recorder 24 receives the voice files from the authors, digitally records the call, and sends the recorded voice job to voice file converter 18. Of course, a user can transmit a previously recorded dictation job in analog format via public switched telephone network 28 to voice recorder 24. Methods for recording analog voice are known and it is presumed that one of ordinary skill in the art could implement this function on a suitable hardware platform.

Voice recorder 24 is arranged to prompt the author for account information to identify the author for subsequent delivery and billing purposes. Voice recorder 24 preferably receives the identification information from the author in the form of dual tone multi-frequency (“DTMF”) signals and passes the identification information to voice file converter 18 for subsequent inclusion/attachment with the dictation file. Voice recorder 24 preferably creates a digital voice file in the WAV or VOX formats.

Voice file converter 18 is any hardware platform arranged to receive the digitized voice file from voice recorder 24 and convert the file to a further compressed version, which serves as the system standard encoding format, such as a file in the MP3 format. User attributes such as user preferences, templates to be used, job priority, account information, and the like, are written to the converted file header for transmission to PIA server 16. It is presumed that one of ordinary skill in the art could arrange suitable hardware to implement the above-described functions, such as suitable microprocessor, input/output devices, storage, network communication connectivity and the like.

As noted above, an author can also input dictation jobs via customer computer 14 in which the jobs are submitted in a digitized format. These formats may be in a format other than the preferred, system standard format implemented by the developer of system 10. For purposes of the described embodiment, the system standard format as noted above is the MP3 format. As such, a user who inputs a digitized transcription file in a format other than the MP3 format, such as the WAV or VOX formats, via customer computer 14 would preferably transmit these files, via FTP or email to voice file converter 18. Voice file converter 18 converts the file using know/file conversion techniques to the system standard file format. Once converted, the job audio and attributes are transferred to PIA server 16.

PIA server 16 is a computing hardware platform arranged to implement the functions described herein. PIA server 16 includes a microprocessor, volatile and non-volatile storage, input/output devices, a monitor and hardware for connectivity to Internet 12, each of which are sized to accommodate expected loading. It is presumed that one of ordinary skill in the art could determine appropriate hardware capacities to implement the present invention. Further, PIA server 16 can be implemented using any suitable operating system such as UNIX and those made available by Microsoft, e.g. Windows, and their derivatives thereof. In the broadest sense, PIA server 16 receives jobs via Internet 12 from customer computer 14 and/or voice file converter 18 as described above. PIA server 16 applies job transfer logic, as discussed below, to allocate the job to a transcription center 22 and transcriptionist workstation 36.

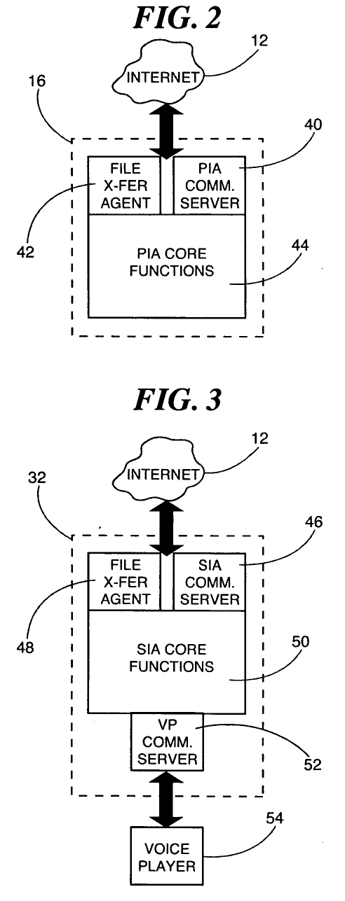

The functional components of PIA server 16 are described with reference to FIG. 2. PIA server 16 includes PIA communication server 40, file transfer agent 42 and PIA core functions 44. PIA communication server 40, file transfer agent 42 and PIA core functions 44 are shown as separate modules, it being understood that each module can be implemented separately on separate computing platforms or integrated within a single platform and/or single executable program.

PIA communication server 40 is a communication engine which enables communication between SIA servers 32 and PIA server 16. As discussed below in detail, PIA communication server 40 manages communication for items such as overall job transfer between PIA server 16 and SIA server 32, communications involving transcription center and transcriptionist allocation, as well as other details regarding establishing, maintaining, and monitoring communications between PIA server 16 and SIA server 32. PIA communication server 40 receives notifications from SIA server 32 for changes originating at transcriptionist center 22 such as changes in the status of a job and changes in the status of a quality controller/workstation or transcriptionist/workstation. PIA communication server 40 also sends notifications to SIA server 32 for changes such as changes in the status of a transcriptionist center 22, transcriptionist/workstation, priority of a job, template, etc.

File transfer agent 42 monitors and manages the transfer of audio files and completed jobs between PIA server 16 and SIA server 32 via Internet 12. File transfer agent 42 monitors remote folders, such as folders within SIA servers 32, for jobs. When a job destined for PIA server 16 is found, file transfer agent 42 pulls the job. It is presumed that one of ordinary skill in the art could design and implement a file transfer agent suitable for carrying out the function of transferring files between two computers.

PIA core functions 44 is preferably implemented as a Windows 32 bit executable program developed as a multiple document interface (“MDI”). PIA core functions 44 manages and tracks the jobs through system 10. For example, PIA core functions 44 include functions for tracking and managing unallocated jobs, that is jobs which are not allocated to any TC workstation 36, manages running jobs, that is all jobs assigned to TC workstations 36, provides statuses of all the jobs in the entire system 10, manages the connectivity status of SIA servers 32 with PIA server 16. PIA core functions 44 are best understood and are explained below with reference to the process flow of the present invention.

Referring again to FIG. 1, TC workstations 36 can be any suitable hardware platform, such as a personal computer, laptop computer, Macintosh, UNIX workstation, and the like, capable of communicating with PIA server 16 over the Internet as well as the other components within transcription center 22 over network 30. TC workstation 36 and QC workstation 38 each include a microprocessor, input/output devices, storage and display monitors as well as any other components known in the art to allow an operator to perform the functions described herein. It is presumed that one of ordinary skill in the art could also appropriately size the components of TC workstation 36 and QC workstation 38 as needed to accommodate expected demand.

Each TC workstation 36 and QC workstation 38 includes a voice player for playing the digitally encoded voice files in the system standard format via speakers and/or headphones coupled to the workstation to allow the transcriptionist in the case of TC workstation 36 or the quality control reviewer in the case of QC workstation 38 to listen to the audio. In the case of TC workstation 36, the transcriptionist listens to the audio dictation corresponding to an assigned job and types the job to create a document. The document can be in the form of a standard template such as may be used in the legal profession or medical profession. In other words, the author may have dictated or established during job entry into the system that the audio file corresponds to a particular predetermined template or form, for example a form used to record patient evaluations. It is contemplated that documents as referred to herein are not limited to word processor creations. Documents can take the form of other file types such as spreadsheets, databases, etc.

The voice player software is arranged to allow a transcriptionist or quality control operator to control the playback of the audio, for example using a foot pedal and/or keyboard and/or mouse to speed up, slow down, advance or reverse the audio. Software for playing back captured digitized voice is known. In the case of QC workstation 38, the quality control operator uses voice player to listen to the dictation and compare the dictation with the transcribed document entered by the transcriptionist via TC workstation 36.

TC workstation 36 communicates with SIA server 32 to receive jobs from SIA server 32 and to send status updates regarding the status of various assigned jobs to SIA server 32. TC workstation 36 and QC workstation 38 can run any suitable operating system, such as UNIX, Windows and the like. The voice player software includes a database which maintains a list of all jobs that have already been downloaded onto the machine as well as jobs finished by the transcriptionist or quality control operator who has logged into that workstation before. This advantageously enables the workstation to recognize if there are any previous pending jobs for any particular user that has logged on and at the same time how many jobs have already been completed by the same logged-in user. It is contemplated that voice player can include the MP3 or standard system audio file decoder and/or can interoperate with an operating system-based media player such as Windows Media Player.

The voice player can be integrated to provide operating system level authentication to allow users who have access permission to log into the network to also use voice player. The voice player communicates with SIA server 32 to allow priority job management so that it can present high priority jobs to the transcriptionist before lower priority jobs. As noted above, the voice player running on TC workstation 36 keeps SIA server 32 notified of the most current state of jobs under process at the workstation, preferably by maintaining a persistent connection.

Database server 34 can be any hardware platform suitable for maintaining a database, such as Microsoft's SQL server, including such hardware components as are known to those of ordinary skill in the art as discussed above with respect to PIA server 16. Each database server 34 includes data relevant to the local transcription center 22, such as tracking the number of pages completed, number of pages completed for each transcriptionist, login and authentication information. Database server 34 also includes and tracks data related to jobs for its corresponding transcription center, such as job ID's, assigned work pool, templates to be used for each job, the audio length of the job, the date and time when the job was created at voice recorder 24 or input via customer computer 14, the status of the job and/or the priority of the job, and the due date of the job.

Of note, although not shown in FIG. 1, it is contemplated that a master database server can be implemented as part of or separate from PIA server 16 to track and store the superset of data stored on each database server 34 within system 10. In other words, each database server 34 stores a subset of the data stored in the system-wide database for data related to its own transcription center 22. By localizing the data within each transcription center 22, communications between SIA server 32 and PIA server 16, and/or database server 34 and the master system-wide database is reduced, thereby avoiding unnecessary network congestion and further improving system performance as well as the performance within each transcription center 22.

Each SIA server 32 is arranged on a hardware platform similar to PIA server 16. Of course, it is presumed that one of ordinary skill in the art would be able to adjust the sizes and capacities of the hardware components to match expected transcription center demand. It is also contemplated that one of ordinary skill in the art could include the appropriate network communication hardware within SIA server 32 to allow communication with Internet 12 and/or network 30. The functions of SIA server can be implemented using any suitable operating system, such as the Windows operating system, UNIX operating system, and the like.

In general, each SIA server 32 communicates with PIA server 16 in a hierarchical fashion. That is, PIA server 16 controls the master functions and allocations for system 10 with each SIA server 32 controlling and performing functions for its designated transcription center 22. Each SIA server 32 includes SIA communication server 46, SIA file transfer agent 48, SIA core functions 50, and voice player communications server 52. Voice player communications server 52 manages data flow and communications with voice players 54, described above, and resident on TC workstations 36 and QC workstations 38. Although SIA communications server 46, file transfer agent 48, SIA core functions 50, and voice player communications server 52 are shown within a single SIA server 32, it is contemplated that these functions can be distributed among multiple pieces of hardware and/or are implemented as separately executable components within SIA server 32.

SIA communications server 46 is a messaging bridge between SIA server 32 and PIA server 16 applications. The communication bridge facilitates exchange notifications and job status information exchanges between SIA server 32 and PIA server 16. In essence, SIA communications server 46 is a complementary mirror image application of PIA communication server 40.

SIA file transfer agent 48 enables physical file transfers between PIA server 16 and SIA server 32. It is preferably implemented as a stand alone and independent component but works with the SIA core functions 50 to facilitate communication and file transfer with PIA server 16 via Internet 12. The primary task of SIA file transfer agent 48 is to initiate automatic logon to PIA server 16 and download jobs for its transcription center 22. File transfer agent 48 is preferably implemented to include auto transfer functions to automatically look for allocated jobs on PIA server 16 and download them to SIA server 32. Further, file transfer agent 48 is preferably implemented with an automatic resumption function to automatically resume file transfer in the event of failed or errored file transfers. SIA file transfer agent 48 compliments PIA file transfer agent 42.

SIA core functions 50 includes the overall core engine server manager which provides the primary interface to SIA server 32 and includes a job manager which implements the basic work flow of jobs at transcription center 22, a center manager module to set and receive parameters specific to the transcription center, for example the center name, address, work shift details, email addresses, and the like and is typically used when setting up the SIA server 32 for the first time or when address changes must be made. SIA core functions 50 also include a user manager module to manage quality control related operations such as creating new quality control ID's and attributes related to a quality control ID such as the quality controller name, role, assigned work pool, and the like. SIA core functions 50 also includes a network manager which allows the center manager to get the network status for all of the workstations in the center network, a report manager to manage all reporting tasks for the center manager, and a consistency manager module which checks job consistencies and debugs job related attributes, for example, the consistency manager module checks for inconsistent information at various levels such as MP3 header information, job files, directory structure, and the like. The specific functions performed by SIA core functions 50, and in particular, the functions performed by the job manager module within each SIA server 32 are best understood by explanation of the entire system, including the interaction between SIA server 32 and the other components of system 10.

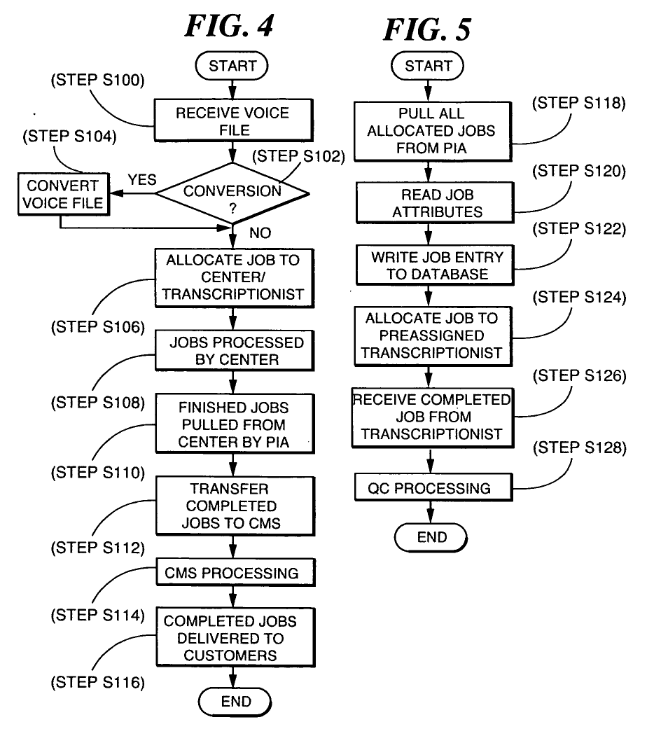

The overall process of the present invention is described with reference to FIG. 4. Initially, system 10 receives a voice file (Step S100) via one of the above-described job input methods. A determination is made as to whether the received voice file needs to be converted (Step S102). The file is converted if it is received in a format other than the standard system format; MP3 as used in the exemplary embodiment. If conversion is required, the voice file is converted by voice file converter 18 into the standard system format (Step S104).

As noted above, jobs in the system standard audio format are stored on PIA server 16 for allocation to a job center and transcriptionist. PIA server 16 applies job transfer logic to allocate the job to a transcription center 22 and a transcriptionist (Step S106). The term “allocate” as used herein refers to assigning a job to a transcription center 22 or a transcriptionist, but not the actual transfer of the file. As an example, the job transfer logic function executing in PIA server 16 considers such attributes as the job priority requested by the author, whether a particular document template is to be used for the corresponding job, whether a particular transcription center 22 and/or transcriptionist has particular expertise or familiarity with the requested template, the number of jobs assigned and outstanding to each transcriptionist center and transcriptionist, the job completion rate for the transcription centers and/or transcriptionist, the number of transcriptionists logged in and available at a transcription center, and the amount of audio to be transcribed. In operation, the job transfer logic function in PIA server 16 tracks the currently running jobs for each TC workstation 36. When a new job is received by PIA server 16, it polls each SIA server 32 for an available TC workstation 36 whose job queue threshold is lower that its currently allocated jobs and which also has the smallest running job total in the transcriptionist work pool. Other factors noted above can also be considered. The new job is then allocated to that TC workstation 36.

System 10 may support a number of different priorities for job completion, each having a different turnaround time and, practically speaking, each resulting in a different charge to the author for the priority basis. For example, the highest priority code may result in no more than a four-hour turnaround time for job completion, ranging down to a number of days for turnaround time.

When a job is allocated to a transcription center 22 and transcriptionist in Step S106, corresponding entries are made in the database maintained by PIA server 16. Once a job has been allocated to a transcription center 22 and transcriptionist, PIA server 16 alerts SIA server 32 of this via the PIA communication server 40/SIA communication server 46 communication infrastructure using Internet 12. Examples of user interactive display screens showing the status of jobs at PIA server 16 and providing a job management interface are described below. Once jobs have been allocated to a transcription center 22 and transcriptionist (Step S106), the jobs are processed by the assigned transcriptionist center (Step S108). Although discussed below in more detail, the job processing generally entails pulling the assigned jobs from PIA server 16 to SIA server 32, having the job transcribed by a transcriptionist on a TC workstation 36, and quality control checking the job.

Once jobs are completed and have been quality control checked, SIA server 32 updates database server 34 as to the entered/completed status of the transcription and similarly alerts PIA server 16 of the updated status via the PIA communications server 40/SIA communications server 46 communication facility. PIA server 16, via PIA core functions 44, accesses SIA server 32 via the PIA file transfer agent 42 and SIA file transfer agent 44 and pulls the data file containing the transcribed job from SIA server 32 to PIA server 16 (Step S110). At this point, the finished jobs are stored in PIA server 16 with the various system databases updated to reflect this status.

The finished jobs are then transferred to the customer management system 20 (Step S112) for final processing such as billing and transfer of the completed document to the author. PIA core functions 44 manages the transfer of the job using, for example, file transfer agent 42; The database corresponding to PIA server 16 is updated to reflect the completion of the job and the transfer to customer management system 20. Customer management system 20 completes final processing of the job (Step S14), and the completed jobs are delivered to the customers (Step S116). Delivery of the jobs is accomplished using the format requested by the author, such as email delivery, hard-copy, facsimile, mail, overnight courier, and the like. Additional details regarding certain of the above-described steps are now explained.

Job processing by transcription center 22, as set forth in Step S108, is described in detail with reference to FIG. 5. As noted above, SIA server 32 periodically polls PIA server 16 to ascertain whether any jobs have been assigned by PIA server 16 to its corresponding transcription center 22. If a job has been assigned, SIA server 32 initiates transfer of the job from PIA server 16 to SIA server 32 (Step S118). In other words, SIA server 32 pulls allocated jobs from PIA server 16. These tasks are managed by SIA core functions 50. By off loading the polling and job pulling tasks to SIA servers 32, processing resources of PIA server 16 are conserved. In other words, by hierarchically distributing the polling and file transfer management tasks to the transcription centers 22, PIA server 16 is left to manage incoming jobs and manage the transfer of jobs to customer management system 20.

As noted above, each job includes a corresponding set of attributes. SIA server 32 reads the job attributes corresponding to the job (Step S120) and writes a job entry to database server 34 (Step S122). The job entry written to the database in the corresponding database server 34 preferably includes the attributes set out in Table 1 below.

TABLE 1
JOB ATTRIBUTES

Job ID
Author ID
Work Type - defines the type of transcription such as medical, legal
insurance, etc.
Template ID - for template required for job
File Size - number of bytes of digitized audio transcription file
Job Play Time - length of audio transcription file in hours, minutes,
seconds
Job Line Count - number of transcribed lines
Assigned Transcriptionist Center
Assigned Transcriptionist Group - transcriptionists can be grouped within
a transcriptionist center and a job assigned to a transcriptionist within
a particular group
Job Status - location of job within the workflow such as PIA server 16,
SIA server 32, TC Workstation 36, etc.
Job Completion Percentage - percentage is based on how much audio has
been played by the transcriptionist
Job Priority
Job Allocation Boolean String - indicates whether or not job has been
allocated to a transcriptionist at a transcriptionist center 22
Assigned Transcriptionist
Assigned Quality Controller
Job Due Time
Job Due Date
Document Format - specifies format of transcribed document such as
WORD, WORDPERFECT, Rich Text, PDF, etc.

Of course, upon initial database entry, certain of these attributes are valueless such as Job Line Count, Assigned Quality Controller, etc. Values are assigned to these attributes as the they become available.

SIA server 32 allocates the job to the transcriptionist pre-assigned by PIA server 16 (Step S124). The transcriptionist uses the voice player software to transcribe the audio dictation in the standard system audio format to a document using TC workstation 36 that the transcriptionist is logged into. Step S124 is described in additional detail below. When the dictation has been transcribed, SIA server 32 receives the completed job from TC workstation 36 (Step S126). SIA server 32 updates database server 34 to reflect that the job has been entered and is ready for quality control analysis.

SIA server 32 allocates the completed job to a quality control worker and corresponding QC workstation 38 for quality control processing (Step S128). QC processing Step S128 is described in detail below, but fundamentally involves reviewing the transcribed job for accuracy. Of note, although a single QC workstation 38 is shown in FIG. 1, it is contemplated that transcription centers 22 can include multiple QC workstations 38, as necessary, based on transcription center demand.

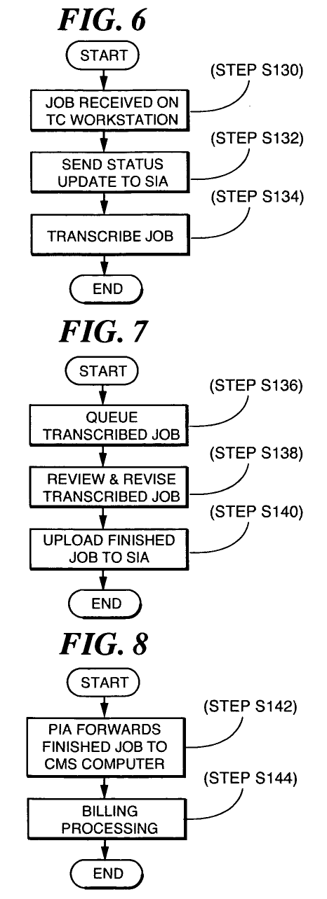

Step S124, allocating a job to the pre-assigned transcriptionist, is explained in detail with reference to FIG. 6. Initially, when a job is allocated to the transcriptionist, SIA server 32 transfers the corresponding audio file to TC workstation 36 corresponding to the assigned transcriptionist (Step S130). The job attributes set out in Table 1 above are included with the audio file, for example by appending the job attribute data to the audio file. As the transcriptionist begins working on the job, TC workstation 36 transmits periodic status updates to SIA server 32 (Step S132). Status updates include indications that the job has been downloaded to TC workstation 36, that the job has been opened for processing, that the transcriptionist has begun working on the job, that the job has been completed and is being uploaded, etc. Once received on TC workstation 36 and opened, the transcriptionist transcribes the job (Step S134). When the job is completed, TC workstation 36 uploads the transcribed job to SIA server 32 (Step S126). Of note, although Step S132, send status update to SIA server 32, is shown sequentially as occurring after the job has been received on TC workstation 36, and before the job has been transcribed, no such sequential limitation is intended. As noted above, status updates are periodically sent by PC workstation 36 to SIA server 32 throughout the transcription process.

Step S128, quality control processing, is described in detail with reference to FIG. 7. Once the transcribed job has been received by SIA server 32 from TC workstation 36, the job is ready for quality control processing. Initially, SIA server 32 queues the transcribed job for quality control processing (Step S136). At this stage, SIA server 32 waits for a QC workstation 38 to become available. As soon as quality controller and corresponding QC workstation 38 become available, the topmost job in the queue is assigned to that quality controller. For example, jobs can be prioritized by least time remaining for delivery in the quality control queue. The job is moved to the respective folder of the designated quality controller from where QC workstation 38 downloads the job. In other words, SIA server 32 provides folders for each quality controller from which QC jobs are transferred to QC workstation 38 for review. When the quality controller is allocated a job and the job transferred to the corresponding QC workstation 38, the quality controller reviews and revises the transcribed job (Step S138) to be sure that the job corresponds to the dictated audio. QC workstation 38 and SIA server 32 interact as described above with respect to PC workstation 36 and Step S132 to provide periodic status updates to SIA server 32 regarding the status of the quality control analysis. Once the job has been reviewed and revised, QC workstation 38 uploads the finished job to SIA server 32 (Step S140). SIA core functions 50 moves the job to a location within SIA server 32 from which PIA file transfer agent 42 can pull the job and move it to the “finished” stage. When PIA file transfer agent 42 pulls the job and the job is successfully transferred to PIA server 16, PIA server 16 alerts SIA server 32 of the delivery using the PIA communications server 40/SIA communications server 46 communication link.

Step S14, customer management system processing, is described in detail with reference to FIG. 8. Once a finished job has been received by PIA server 16 and the accompanying databases updated to reflect the status of the finished job, such as database server 34 corresponding to the transcription center 22 at which the job was completed, PIA server 16 forwards the finished job to customer management system computer 20 (Step S142). The forwarded finished job includes the attributes relevant for billing such as author identification, priority, finished job delivery method, and the like. Customer management service computer 20, or a separate billing computer, conducts billing processing for the job (Step S144) to create an invoice and/or billing entry for the job. Methods and processes for invoicing customers are well-known and are not described herein. Once billing processing is complete, the job is delivered to the customer as shown in Step S116 in FIG. 4.

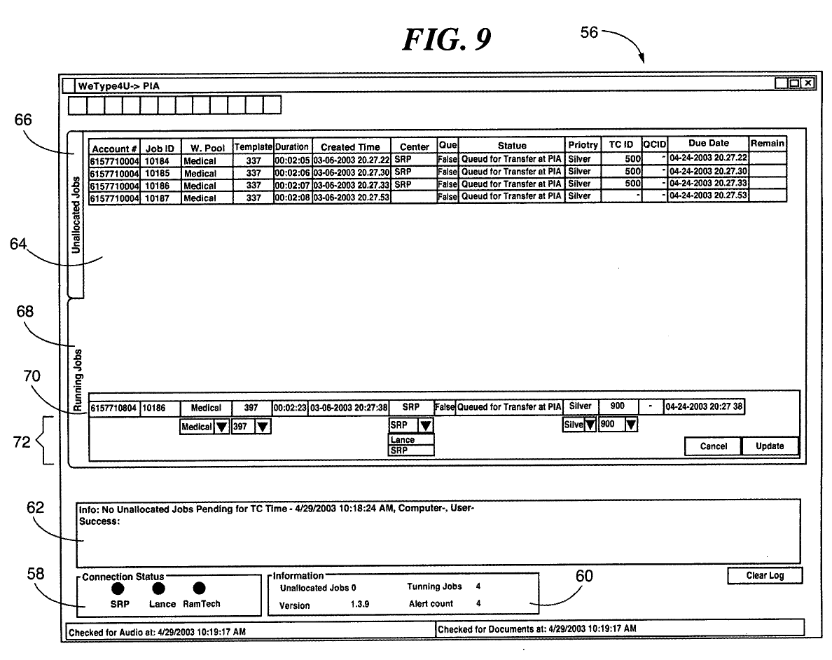

PIA server 16 includes, as part of PIA core functions 44, a job management display screen which allows for efficient interactive management of system 10 and the jobs therein. An exemplary PIA display screen 56 is described with reference to FIG. 9. PIA display screen 56 includes connection status area 58, information summary area 60, log area 62, job detail area 64, unallocated jobs tab 66, running jobs tab 68, selected job status area 70, and attribute change area 72. Connection status area 58 provides an indication of the connectivity between PIA server 16 and the SIA servers 32 in system 10. It is contemplated that the connection status indicators within connection status area 58 can be color coded to reflect the status of connectivity in real time. For example, a red status indicator corresponds to a disconnected state, a yellow indicator indicates that the connection to the corresponding SIA server 32 is okay, but that the functional processes within the SIA server 32 are not running, and a green status indicator indicates that PIA server 16 is connected to and interoperable with SIA server 32.

Information summary area 60 provides information regarding the total number of unallocated jobs in the system, the number of running jobs in the system, the number of jobs for which there is an alert displayed, and the version number of the PIA server 16 software. Log area 62 provides logging information about various activities which have occurred within PIA server 16. Job detail area 64 provides information for each unallocated job in the case where unallocated jobs tab 66 is selected and running jobs in the case where running jobs tab 68 is selected. The term selected as used herein refers to the act of using a pointing device or other keyboard stroke combination to indicate that a desired action take place by clicking the mouse button, entering keystrokes, etc. Shown in FIG. 9 is job detail area 64 corresponding to running jobs tab 68. Similar information is displayed for each job within job detail area 64 when unallocated jobs tab 66 is selected.

Job detail area 64 includes, for each job, the associated author account number, a job ID assigned by PIA server 16, the corresponding work pool and template, if applicable, for the job, the duration of the audio dictation, the time and date that the job was created, the transcription center 22 assigned to transcribe the job, a transfer field indicating the status if the job has been transferred to TC center 32 or whether it is still resident at PIA 16, the current status of the job, the priority of the job, the ID of the transcriptionist assigned to the job, the ID of the quality controller assigned to the job, the time when the job is required to be returned to the customer, and with respect to the current system time and due date, how much time is left for the job until it is must be returned to the customer. It is contemplated that each column of information corresponding to a job can be color coded to reflect various alerts which may affect the job. For example, a job that is reaching its turnaround time and which requires attention by someone at the corresponding transcription center 22 can be turned yellow, while a job that has reached its turnaround time and has still not been transcribed, quality checked and returned to the PIA can be turned red, indicating the need for immediate attention. It is contemplated that the threshold settings for enabling a particular color can be adjusted by a user having proper authority such as an administrator.

While certain attributes for each job remain fixed, such as the due date, account number, and job ID, other attributes can be changed. By selecting a job in job detail area, the attributes corresponding to the selected job are displayed in selected job at status area 70. Attributes which may be changed for that job are shown in attribute change area 72 and can be changed, for example, via drop down selection lists. As shown in FIG. 9, attribute change area 72 allows modification of the assigned work pool, job template, transcription center assigned to the job, job priority, and transcriptionist ID. A user selects the “update” button within attribute change area 72 to update the database and PIA server 16 with the modified attributes.

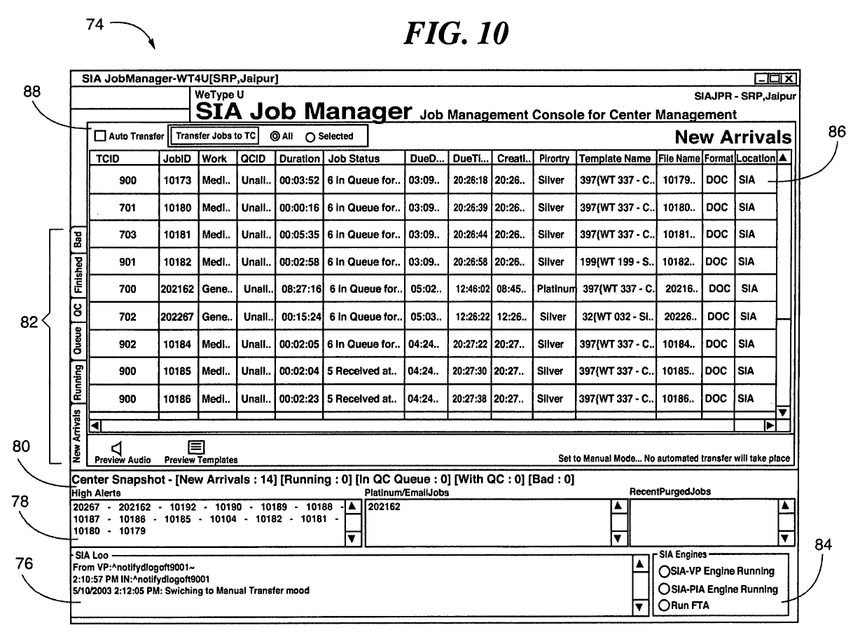

As with PIA server 16 and its associated software, SIA servers 32 include, as part of SIA core functions 50, a display screen and associated software which enables operators to manage jobs at the SIA level, an example of which is shown as SIA display screen 74 in FIG. 10. As shown in FIG. 10, SIA display screen 74 includes SIA log information area 76, high alerts area 78, snapshot area 80, stage tabs 82, engine status area 84, job information grid 86, and job transfer management area 88. SIA log information area 76 provides general information about activities occurring within SIA server 32. High alerts area 78 displays those job ID's assigned to SIA server 32 which have high alerts, such as the case when a job is overdue.

Snapshot area 80 provides a summary of jobs assigned to SIA server 32, including the number of new arrivals, the number of jobs running, the number of jobs in the quality control queue, the number of jobs currently with quality control, the number of jobs which are finished, and the number of jobs for which there is a problem.

Stage tabs 82 are selectable tabs which, when selected, display jobs in job information grid 86 corresponding to the selected stage. Stage tabs 82 include tabs for new job arrivals, running jobs, queued jobs, jobs with quality control, finished jobs, and bad jobs. Job information grid 86 displays, for each job, the ID of the assigned transcriptionist, the job ID, the work group, the quality controller ID, the duration of the job, the job status, the due date and time for the job, the date the job was created, the priority of the job, the name of the template the job is to be created with, the file name for the job, the file format for the job, and the current location of the job. In addition, the column corresponding to the assigned transcriptionist can include job icons which convey not only the job location and status, but also the job priority in a graphical manner. For example, it is contemplated that icons showing the status that a job has been received at SIA 32, the job is in the queue at SIA 32, the job is with the transcriptionist, the job is with the quality controller, or the job has been completed can all be quickly and easily shown using predetermined icons.

Engine status area 84 is arranged to provide a color-coded view showing the status of the various modules associated with SIA server 32. Job transfer management area 88 allows SIA servers 32 operator to establish how SIA server 32 should handle new arrival job transfers. Job transfer manager 88 includes a check box to indicate that SIA server 32 should operate in auto transfer mode. In auto transfer mode, SIA server 32 periodically checks for new arrivals, and if a new job has been allocated to SIA server 32, one of three actions are taken. First, when a job arrives for a specific transcriber and that transcriber is not occupied with any other job, the job is assigned to that particular transcriber and moved to a storage area within SIA 16 corresponding to that transcriptionist. The job is also moved to appear under the running jobs tab, with corresponding updates and entries made to database 34. Second, when a job arrives for a specific transcriptionist and that transcriptionist is already occupied with a job, the job remains in the new arrivals tab and the status of the job is changed to “in queue at SIA for the TC” meaning that as soon as the TC finishes the current job, the new job will be assigned to that transcriptionist and will automatically revise the database to cause the corresponding job to appear under the running tab. Third, when a job arrives for a specific transcriptionist and the transcriptionist is already occupied with a job, and there is an existing job already queued for the transcriptionist as new arrival, the job remains in the new arrivals tab with the status “received at SIA”, meaning that the job will remain in the queue as there is already a job in the queue that will be sent to the transcriptionist when the current job is finished. When the job before the new job is moved to the running tabs, the status of the newly received job is promoted to “in queue at SIA for TC”.

By un-checking the auto transfer box, SIA 32 runs in manual transfer mode. Manual transfer mode allows the operator to manually move the jobs to the running jobs tab by clicking the “transfer jobs to TC” button shown in transfer management area 88. This option allows the operator to transfer all jobs to the transcriptionist or only selected jobs. Jobs can be transferred to a different transcriptionist by entering manual transfer mode and changing the transcriptionist ID for the jobs to be transferred. This causes database 34 to be updated as well as the database corresponding to PIA server 16.

The present invention advantageously provides an efficient mechanism for job management as well as a hierarchical system component arrangement which allows for the efficient management of jobs and job flow within system 10.

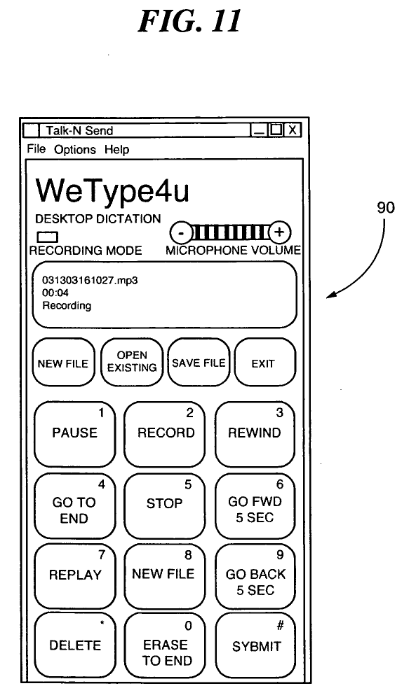

As discussed above, the present invention advantageously provides an arrangement by which an author can dictate, using a microphone, directly into his or her computer using audio capture software that is integrated with system 10 in such a manner as to allow efficient dictation job entry. An exemplary display screen is shown in FIG. 11. Computer dictation display screen 90 provides a simple, yet comprehensive interface which allows an author to create an audio dictation file which, upon completion, is automatically transmitted from customer computer 14 to PIA server 16, and corresponding database entries in PIA server 16 made to create a corresponding job. The computer dictation software records the author's voice in the system standard file format so no further conversion is necessary.

As shown in FIG. 11, the user can create a new audio file, open an existing file, save the file, and exit, as well as control aspects of voice recording. Upon completion, the user selects the submit button to transfer the job to PIA server 16 and create a new job.

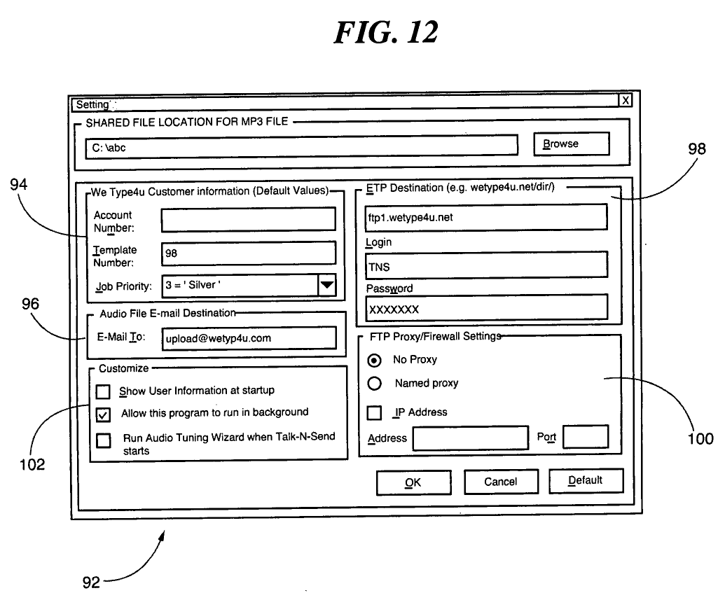

In order to facilitate integration between the computer dictation software and the other components of system 10, for example, PIA server 16, the computer dictation software resident on customer computer 14 allows the software to be configured with and store set-up (default) values. FIG. 12 shows an exemplary computer dictation set-up screen 92 displayed on customer computer 14. Computer dictation set-up screen 92 includes customer information 94, email destination area 96, FTP destination configuration area 98, proxy configuration area 100, and customization area 102. Customer information area 94 allows an author to store his or her account number, default template identification number and default job priority. Email destination area 96 allows the author to store the destination for which audio files submitted for processing will be emailed to as an attachment. FTP destination configuration area 98 allows an author to define the address and login information for audio files submitted to system 10 via FTP. Proxy configuration area 100 allows an author to establish whether an FTP proxy or firewall is included as part of the system and if so, specify the configuration parameters for that device. Customization area 102 allows a user to select particular customization options, such as whether user information is shown at startup, whether the computer dictation software can run as a background task, and whether an audio tuning wizard launches to automatically check the characteristics of the digital signal processing software to optimize analog to digital audio conversion when the computer dictation software starts.

By allowing the set-up and default information to be prestored, the present invention allows the job entry portion of the system to be tightly integrated with the system, thereby reducing inefficiencies due to error, file format conversion time, processing delays and the like.

The present invention advantageously provides an integrated hierarchical system which accommodates audio file input in a multitude of formats, provides an efficient set of processes for allocating jobs to transcription centers, monitoring the progress of the jobs, managing quality control over the jobs, and providing the completed transcribed jobs to the author via email or other designated delivery method period.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A digital voice transcription system comprising:
a digital communication network;
a first server operatively coupled to the digital communication network, the first server storing a digital transcription job file corresponding to an author's voice, the first server allocating stored job files for transcription;
a second server corresponding to a transcription center operatively coupled to the digital communication network, the second server being in digital communication with the first server, the second server arranged to initiate transfer of digital transcription job files allocated to the second server from the first server to the second server.

2. The digital voice transcription system of claim 1, wherein the first server generates and transmits a message to the second server indicating that a job has been allocated to the corresponding to at least one transcription center.

3. The digital voice transcription system of claim 1, further comprising a voice file converter operatively coupled to the digital communication network, the voice file converter converting digitized audio files into digital transcription job files having a system standard encoding format.

4. The digital voice transcription system of claim 3, wherein the voice file converter transfers the digital transcription job files and job attributes corresponding to at least one of the author and a job priority to the first server.

5. The digital voice transcription system of claim 3, further including:
a telephone network;
a voice recorder operatively coupled to the voice file converter and the telephone network, the voice recorder creating the digitized voice file from a call received via the telephone network.

6. The digital voice transcription system of claim 1, further including:
an audio input device; and
a customer computer operatively coupled to the digital communication network and the audio input device, the customer computer arranged to:
receive audio from the audio input device, the received audio corresponding to the author's voice;
receive data from the author corresponding to at least one predetermined job attribute;
convert the received audio to the digital transcription job file, the digital transcription job file being in a standard system encoding format; and
transfer the digital transcription job file and at least one predetermined job attribute to the first server.

7. The digital voice transcription system of claim 1, wherein the standard system format is MP3.

8. The digital voice transcription system of claim 2, wherein the first server includes:
a first file transfer agent, the first file transfer agent managing file transfers between the first server and the second server; and
a first communication server, the first communication server managing messaging communications between the first server and the second server, the messaging communications including the message sent to the second server indicating that a job has been allocated to the corresponding to at least one transcription center.

9. The digital voice transcription system of claim 1, wherein the allocation by the first server includes allocation to a second server and a transcriptionist, the digital voice transcription system further including a transcriptionist workstation in operative digital communication with the second server, the transcriptionist workstation:
receiving a digital voice transcription job allocated to the transcriptionist corresponding to the transcriptionist workstation;
sending status updates to the second server, the status updates including data indicating the status of the transcription of the digital voice transcription job; and
sending a transcribed digital voice transcription job to the second server.

10. The digital voice transcription system of claim 9, further including a quality control workstation in operative digital communication with the second server, the quality control workstation:
receiving a transcribed digital voice transcription job from the second server;
sending status updates to the second server, the status updates including data indicating the status of review of the transcribed digital voice transcription job; and
sending a reviewed transcribed digital voice transcription job to the second server.

11. The digital voice transcription system of claim 1, wherein the first server includes a first display monitor operable to display a first job management display screen, the first job management display screen providing:
an indication of the status of communication between the first server and the second server;
a listing of unallocated digital transcription jobs; and
a listing of running digital transcription jobs.

12. The digital voice transcription system of claim 11, wherein the listing of allocated jobs includes attributes corresponding to each allocated job, the attributes including an author account number, a job identification number, a job priority, an assigned transcriptionist identification number, an assigned transcription center identification number and a duration of the audio dictation.

13. The digital voice transcription system of claim 1, wherein the second server includes a second display monitor operable to display a second job management display screen, the second job management display screen providing:
a plurality of selectable stage tabs corresponding to selected stages of digital transcription job completion; and
a job information grid, the job information grid providing information corresponding to each job allocated to the second server for a selected stage.

14. The digital voice transcription system of claim 13, wherein the information corresponding to each job allocated to the second server provided in the job information grid for a selected stage includes a job identification number, a job priority, an assigned transcriptionist identification number and a due date and time for completion of the digital transcription job.

15. A digital voice transcription method comprising:
storing a digital transcription job file corresponding to an author's voice,
allocating stored job files for transcription, allocation including assigning a transcription center and transcriptionist;
transferring digital transcription job files allocated to the transcription center to a server corresponding to the allocated transcription center, the file transfer being initiated by the server corresponding to the allocated transcription center.

16. The method of claim 15, further comprising transmitting a message to the server indicating that a job has been allocated to the corresponding at least one transcription center.

17. The method of claim 15, further comprising converting digitized audio files into digital transcription job files having a system standard encoding format.

18. The method of claim 17, further comprising storing job attributes corresponding to at least one of the author and a job priority for each digital transcription job file.

19. The method of claim 17, further including:
receiving a call from an author via a telephone network;
creating the digitized voice file from the call received via the telephone network.

20. The method of claim 15, further including:
receiving audio from an audio input device coupled to a customer computer, the received audio corresponding to the author's voice;
receiving data from the author corresponding to at least one predetermined job attribute; and
using the customer computer to convert the received audio to the digital transcription job file, the digital transcription job file being in a standard system encoding format.

21. The method of claim 20, wherein the standard system format is MP3.

22. The method of claim 15, further including:
providing a digital voice transcription job allocated to the transcriptionist to a transcriptionist workstation corresponding to the transcriptionist;
sending a first status update to the server, the first status update including data indicating the status of the transcription of the digital voice transcription job; and
sending a transcribed digital voice transcription job to the server.

23. The method of claim 22, further including:
providing a transcribed digital voice transcription job to a quality control workstation;
sending a second status update to the server, the second status update including data indicating the status of review of the transcribed digital voice transcription job; and
sending a reviewed transcribed digital voice transcription job to the server.

24. The method of claim 15, further comprising:
tracking unallocated digital transcription jobs and running allocated digital transcription jobs;
displaying a listing of the unallocated digital transcription jobs; and
displaying a listing of the running digital transcription jobs.

25. The method of claim 24, wherein the listing of allocated jobs includes attributes corresponding to each allocated job, the attributes including an author account number, a job identification number, a job priority, an assigned transcriptionist identification number, an assigned transcription center identification number and a duration of the audio dictation.

26. The method of claim 15, further comprising:
providing a plurality of selectable stage tabs corresponding to selected stages of digital transcription job completion; and
displaying a job information grid, the job information grid providing information corresponding to each job allocated to the server for a selected stage.

27. The method of claim 26, wherein the information corresponding to each job allocated to the server provided in the job information grid for a selected stage includes a job identification number, a job priority, an assigned transcriptionist identification number and a due date and time for completion of the digital transcription job.

28. A digital transcription method for a transcription system having a centralized location and at least one transcriptionist center in which at least one transcriptionist is assigned to each of the at least one transcriptionist centers, the method comprising:
receiving a transcription job at the centralized location;
allocating the transcription job to a transcription center and transcriptionist, the allocated transcription center initiating transfer of the allocated job from the centralized location to the allocated transcription center;
processing the transcription job within the allocated transcription center to create a transcribed document; and
transferring the transcribed document to the centralized location.

29. The method of claim 28, wherein each transcription job includes a digitized audio file and a corresponding set of attributes, processing the transcription job comprising:
writing a job entry to a database for the transcription job, the job entry including the attributes for the transcription job;
providing the transcription job to a transcription workstation corresponding to the allocated transcriptionist; and
transcribing the transcription job.

30. The method according to claim 29, further comprising quality control checking the transcribed job.

31. The method according to claim 30, wherein the quality control checking comprises:
assigning a quality control operator at the allocated transcription center;
queuing the transcribed job for quality control review by the assigned quality control operator; and
providing the transcribed job to a quality control workstation corresponding to the assigned quality control operator.

32. The method according to claim 28, further comprising:
receiving a voice file from an author;
converting the voice file into a system standard digital transcription file;
storing the system standard digital transcription file at the centralized location.

33. The method according to claim 29, wherein the attributes include a priority for the corresponding transcription job, a transcriptionist ID for the allocated transcriptionist and a transcription center ID for the allocated transcription center.

34. The method according to claim 28, further comprising storing set-up data on a user's computer, the set-up data facilitating automatic submission of a transcription job from the user's computer to the centralized location.

35. The method according to claim 34, wherein the setup data includes one or more of an email destination address corresponding to a system email address for the submission of transcription jobs, a default job priority, a default template and an FTP destination corresponding to a TCP/IP address for the submission of transcription jobs.
